(19) United States
(12) Patent Application Publication
(10) Pub. No.: US 2016/0138989 A1
(43) Pub. Date: May 19, 2016

(54) ELECTRONIC DEVICE, PHYSICAL QUANTITY SENSOR, PRESSURE SENSOR, ALTIMETER, ELECTRONIC APPARATUS, AND MOVING OBJECT

(71) Applicant: Seiko Epson Corporation, Tokyo (JP)

(72) Inventor: Nobuyuki TANAKA, Chino (JP)

(21) Appl. No.: 14/941,942

(22) Filed: Nov. 16, 2015

(30) Foreign Application Priority Data
Nov. 17, 2014 (JP) 2014-233106

(51) Int. Cl. G01L 9/00; G01C 5/06

(52) U.S. Cl. CPC G01L 9/008; G01L 9/0054; G01C 5/06

(57) ABSTRACT

A physical quantity sensor includes a substrate, a piezoelectric resistive element that is disposed on one surface side of the substrate, a wall portion that is disposed on the one surface side of the substrate so as to surround the piezoelectric resistive element in a plan view of the substrate, and a ceiling portion that is disposed on an opposite side to the substrate with respect to the wall portion and forms a cavity along with the wall portion, in which an inner circumferential edge of an end portion of the wall portion on an opposite side to the substrate includes curved portions which are curved in the plan view.

### CROSS REFERENCE

This application claims benefit of Japanese Application JP 2014-233106, filed on Nov. 17, 2014. The disclosure of the prior application is hereby incorporated by reference herein in its entirety.

### BACKGROUND

1. Technical Field

The present invention relates to an electronic device, a physical quantity sensor, a pressure sensor, an altimeter, an electronic apparatus, and a moving object.

2. Related Art

There is an electronic device including a cavity which is formed by using a semiconductor manufacturing process (for example, refer to JP-A-2014-115208). As an example of such an electronic device, there is a MEMS element related to JP-A-2014-115208, and the MEMS element includes a substrate, a resonator which is formed on a main surface of the substrate, and a space wall portion which is formed over the main surface of the substrate and forms a space for accommodating the resonator. In the MEMS element related to JP-A-2014-115208, a part of the substrate is thinned and thus functions as a diaphragm. In addition, pressure is detected on the basis of changes in frequency characteristics of the resonator due to deflection of the diaphragm caused by received pressure.

However, in the MEMS element related to JP-A-2014-115208, since an inner circumference of the space wall portion (sidewall) has a rectangular shape in a plan view so as to correspond to a plan-view shape of the diaphragm, stress concentrates on portions corresponding to the corners of the sidewall of a ceiling portion of the space wall portion when the ceiling portion is thermally contracted, and, as a result, there is a problem in that damage such as cracking occurs in the ceiling portion.

### SUMMARY

An advantage of some aspects of the invention is to provide an electronic device and a physical quantity sensor with high reliability, and to provide a pressure sensor, an altimeter, an electronic apparatus, and a moving object having the electronic device.

The invention can be implemented as the following application examples.

### Application Example 1

An electronic device according to this application example includes a substrate; a functional element that is disposed on the substrate; a wall portion that is disposed on one surface side of the substrate so as to surround the functional element in a plan view of the substrate; and a ceiling portion that is disposed on an opposite side to the substrate with respect to the wall portion and forms an internal space along with the substrate and the wall portion, in which an inner circumferential edge of an end portion of the wall portion on the ceiling portion side includes curved portions which are bent or curved at obtuse angles in the plan view.

According to the electronic device, by substantially eliminating a portion of the inner circumferential edge of the wall portion which is curved at a right angle or an acute angle in a plan view (a portion which tends to cause stress to be concentrated on the ceiling portion) on an opposite side to the substrate, it is possible to reduce stress which is concentrated on the ceiling portion when the ceiling portion is thermally contracted. For this reason, it is possible to reduce damage due to the thermal contraction of the ceiling portion. Therefore, it is possible to provide the electronic device having high reliability.

### Application Example 2

In the electronic device according to the application example, it is preferable that the number of the curved portions is five or more.

With this configuration, even if the inner circumferential edge of the end portion of the wall portion on the opposite side to the substrate has curved portions in the plan view, all angles of the portions may be obtuse angles. In other words, it is possible to eliminate a portion of the inner circumferential edge of the end portion of the wall portion which is curved at a right angle or an acute angle in a plan view around the entire circumference on the opposite side to the substrate.

### Application Example 3

In the electronic device according to the application example, it is preferable that each of the curved portions has a shape formed along a circular arc in the plan view.

With this configuration, it is possible to reduce stress which is concentrated on the ceiling portion when the ceiling portion is thermally contracted.

### Application Example 4

In the electronic device according to the application example, it is preferable that the inner circumferential edge has a circular shape or an elliptical shape in the plan view.

With this configuration, it is possible to reduce stress which is concentrated on the ceiling portion when the ceiling portion is thermally contracted.

### Application Example 5

In the electronic device according to the application example, it is preferable that the substrate includes a diaphragm that is provided at a position which overlaps at least a part of the ceiling portion in the plan view and that undergoes deflection deformation due to received pressure.

With this configuration, it is possible to implement the electronic device (physical quantity sensor) which can detect pressure.

### Application Example 6

In the electronic device according to the application example, it is preferable that the functional element is a sensor element which outputs an electric signal due to a strain thereof.

With this configuration, it is possible to improve pressure detection sensitivity.

### Application Example 7

In the electronic device according to the application example, it is preferable that the contour of the diaphragm is a rectangular shape in the plan view.

With this configuration, it is possible to improve pressure detection sensitivity.

### Application Example 8

In the electronic device according to the application example, it is preferable that the inner circumferential edge has a rectangular shape in the plan view.

With this configuration, it is possible to prevent the wall portion from unexpectedly impeding deflection deformation due to received pressure in the diaphragm which is formed in a rectangular shape in the plan view, and also to efficiently dispose the wall portion.

### Application Example 9

A physical quantity sensor according to this application example includes the electronic device according to the application example, in which the functional element is a sensor element.

According to the physical quantity sensor, by substantially eliminating a portion of the inner circumferential edge of the wall portion which is curved with a right angle or an acute angle in a plan view (a portion which tends to cause stress to be concentrated on the ceiling portion) on an opposite side to the substrate, it is possible to reduce stress which is concentrated on the ceiling portion when the ceiling portion is thermally contracted. For this reason, it is possible to reduce damage due to the thermal contraction of the ceiling portion. Therefore, it is possible to provide the physical quantity sensor having high reliability.

### Application Example 10

A pressure sensor according to the application example includes the electronic device according to the application example.

With this configuration, it is possible to provide the pressure sensor having high reliability.

### Application Example 11

An altimeter according to the application example includes the electronic device according to the application example.

With this configuration, it is possible to provide the altimeter having high reliability.

### Application Example 12

An electronic apparatus according to the application example includes the electronic device according to the application example.

With this configuration, it is possible to provide the electronic apparatus having high reliability.

### Application Example 13

A moving object according to the application example includes the electronic device according to the application example.

With this configuration, it is possible to provide the moving object having high reliability.

### BRIEF DESCRIPTION OF THE DRAWINGS

The invention will be described with reference to the accompanying drawings, wherein like numbers reference like elements.

FIG. 1 is a sectional view illustrating a physical quantity sensor according to a first embodiment of the invention.

FIG. 2 is a plan view illustrating an arrangement of a piezoelectric resistive element (sensor element) and a wall portion of the physical quantity sensor illustrated in FIG. 1.

FIGS. 3A and 3B are diagrams for explaining an action of the physical quantity sensor illustrated in FIG. 1, in which FIG. 3A is a sectional view illustrating a pressurized state, and FIG. 3B is a plan view illustrating the pressurized state.

FIGS. 4A to 4D are diagrams illustrating manufacturing steps of the physical quantity sensor illustrated in FIG. 1.

FIGS. 5A to 5C are diagrams illustrating manufacturing steps of the physical quantity sensor illustrated in FIG. 1.

FIG. 6 is a plan view illustrating an arrangement of a piezoelectric resistive element (sensor element) and a wall portion of a physical quantity sensor according to a second embodiment of the invention.

FIG. 7 is a plan view illustrating an arrangement of a piezoelectric resistive element (sensor element) and a wall portion of a physical quantity sensor according to a third embodiment of the invention.

FIG. 8 is a plan view illustrating an arrangement of a piezoelectric resistive element (sensor element) and a wall portion of a physical quantity sensor according to a fourth embodiment of the invention.

FIG. 9 is a sectional view illustrating an example of a pressure sensor according to an embodiment of the invention.

FIG. 10 is a perspective view illustrating an example of an altimeter according to an embodiment of the invention.

FIG. 11 is a front view illustrating an example of an electronic apparatus according to an embodiment of the invention.

FIG. 12 is a perspective view illustrating an example of a moving object according to an embodiment of the invention.

### DESCRIPTION OF EXEMPLARY EMBODIMENTS

Hereinafter, an electronic device, a physical quantity sensor, a pressure sensor, an altimeter, an electronic apparatus, and a moving object according to an embodiment of the invention will be described in detail on the basis of respective embodiments shown in the accompanying drawings.

### 1. Physical Quantity Sensor

### First Embodiment

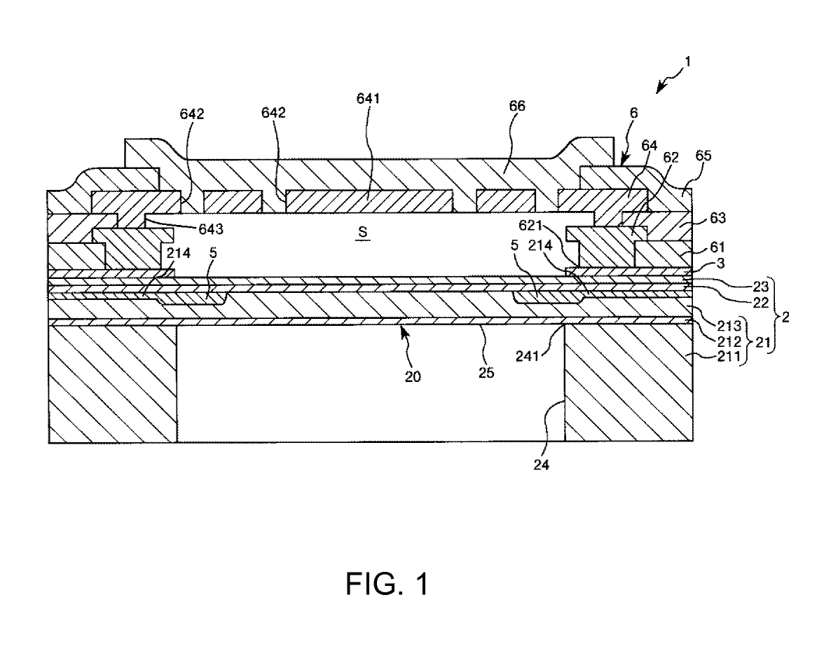

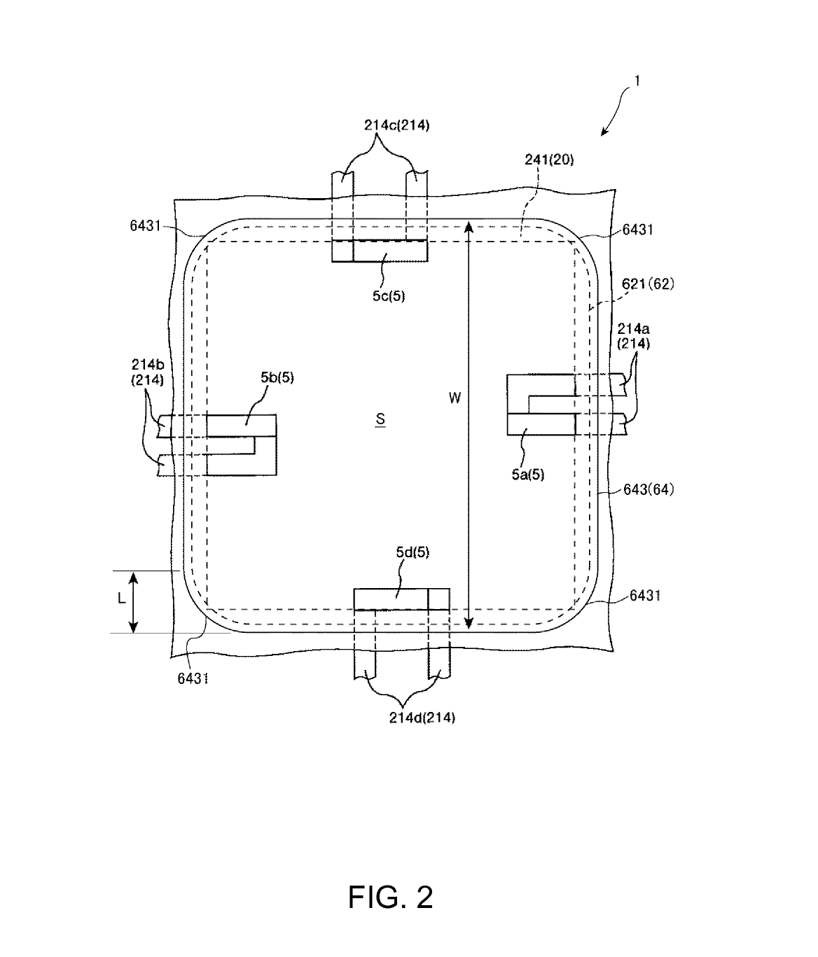

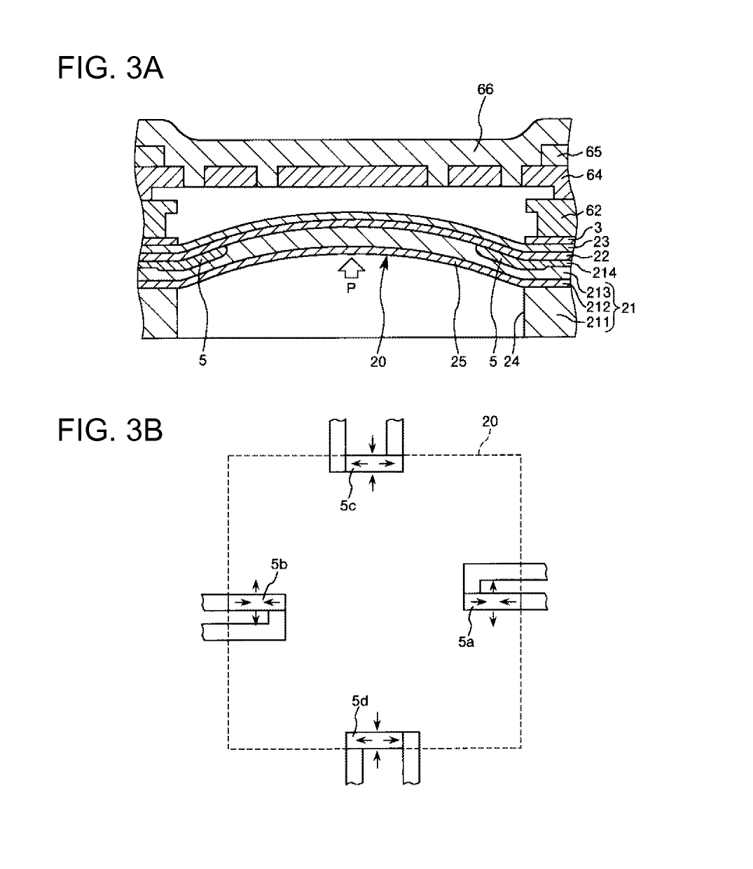

FIG. 1 is a sectional view illustrating a physical quantity sensor according to a first embodiment of the invention, and FIG. 2 is a plan view illustrating an arrangement of a piezoelectric resistive element (sensor element) and a wall portion of the physical quantity sensor illustrated in FIG. 1. FIGS. 3A and 3B are diagrams for explaining an action of the physical quantity sensor illustrated in FIG. 1, in which FIG. 3A is a sectional view illustrating a pressurized state, and FIG. 3B is a plan view illustrating the pressurized state. Hereinafter, for convenience of description, the upper side of FIG. 1 is assumed to be an “upper side”, and the lower side thereof is assumed to be a “lower side”.

A physical quantity sensor 1 illustrated in FIG. 1 includes a substrate 2 provided with a diaphragm 20, a plurality of piezoelectric resistive elements 5 (sensor element) which are functional elements disposed in the diaphragm 20, a stacked structure 6 which forms a cavity S (pressure reference chamber) along with the substrate 2, and an intermediate layer 3 disposed between the substrate 2 and the stacked structure 6.

Hereinafter, each constituent element of the physical quantity sensor 1 will be described sequentially.

### Substrate

The substrate 2 includes a semiconductor substrate 21, an insulating film 22 provided on one surface of the semiconductor substrate 21, and an insulating film 23 provided on a surface of the semiconductor substrate 21, opposite to the surface on which the insulating film 22 is provided.

The semiconductor substrate 21 is an SOI substrate in which a silicon layer 211 (handle layer) formed of single crystal silicon, a silicon oxide layer 212 (box layer) formed of a silicon oxide film, and a silicon layer 213 (device layer) formed of single crystal silicon are stacked in this order. The semiconductor substrate 21 is not limited to an SOI substrate, and may be, for example, other semiconductor substrates such as a single crystal silicon substrate.

The insulating film 22 is, for example, a silicon oxide film, and has insulating properties. The insulating film 23 is, for example, a silicon nitride film, and has insulating properties and also has resistance to an etchant containing hydrofluoric acid. Here, since the insulating film 22 (silicon oxide film) is interposed between the semiconductor substrate 21 (silicon layer 213) and the insulating film 23 (silicon nitride film), the insulating film 22 (silicon oxide film) can reduce stress which is generated during the formation of the insulating film 23 and is delivered to the semiconductor substrate 21. In a case where semiconductor circuits are formed on and over the semiconductor substrate 21, the insulating film 22 may be used as an inter-element isolation film. The insulating layers 22 and 23 are not limited to the above-described constituent materials, and either one of the insulating layers 22 and 23 may be omitted as necessary.

The patterned intermediate layer 3 is disposed on the insulating film 23 of the substrate 2. The intermediate layer 3 is formed so as to surround the periphery of the diaphragm 20 in a plan view, and thus forms a step difference corresponding to a thickness of the intermediate layer 3 on a central side (inside) of the diaphragm 20 between an upper surface of the intermediate layer 3 and an upper surface of the substrate 2. Consequently, when the diaphragm 20 undergoes deflection deformation due to received pressure, stress can be concentrated on a boundary portion of the diaphragm 20 with the step difference. For this reason, it is possible to improve the detection sensitivity by disposing the piezoelectric resistive element 5 at the boundary portion (or in the vicinity thereof).

The intermediate layer 3 is formed of, for example, single crystal silicon, poly-crystal silicon (polysilicon), or amorphous silicon. The intermediate layer 3 may be formed, for example, by doping (diffusing or implanting) impurities such as phosphor or boron with single crystal silicon, poly-crystal silicon (polysilicon), or amorphous silicon. In this case, since the intermediate layer 3 is conductive, for example, in a case where a MOS transistor is formed on the substrate 2 outside the cavity S, a part of the intermediate layer 3 may be used as a gate electrode of the MOS transistor. A part of the intermediate layer 3 may be used as a wiring.

The diaphragm 20, which is thinner than the peripheral portion and undergoes deflection deformation due to received pressure, is provided in the substrate 2. The diaphragm 20 is formed by providing a bottomed recess 24 on a lower surface of the semiconductor substrate 21. In other words, the diaphragm 20 is configured to include the bottom of the recess 24 which is open to one surface of the substrate 2. A lower surface of the diaphragm 20 is a pressure receiving surface 25. In the present embodiment, as illustrated in FIG. 2, the diaphragm 20 has a square (rectangular) shape in a plan view.

In the substrate 2 of the present embodiment, the recess 24 penetrates through the silicon layer 211, and the diaphragm 20 is formed of four layers including the silicon oxide layer 212, the silicon layer 213, the insulating film 22, and the insulating film 23. Here, the silicon oxide layer 212 can be used as an etching stopper layer when the recess 24 is formed through etching in a manufacturing step of the physical quantity sensor 1 as will be described later, and thus it is possible to reduce a variation in the thickness of the diaphragm 20 for each product.

The recess 24 may not penetrate through the silicon layer 211, and the diaphragm 20 may be formed of five layers including a thin portion of the silicon layer 211, the silicon oxide layer 212, the silicon layer 213, the insulating film 22, and the insulating film 23.

### Piezoelectric Resistive Element (Functional Element)

The plurality of piezoelectric resistive elements 5 are formed on the cavity S side of the diaphragm 20 as illustrated in FIG. 1. Here, the piezoelectric resistive elements 5 are formed in the silicon layer 213 of the semiconductor substrate 21.

As illustrated in FIG. 2, the plurality of piezoelectric resistive elements 5 include a plurality of piezoelectric resistive elements 5a, 5b, 5c and 5d which are disposed on an outer circumference of the diaphragm 20.

The piezoelectric resistive element 5a, the piezoelectric resistive element 5b, the piezoelectric resistive element 5c, and the piezoelectric resistive element 5d are disposed so as to respectively correspond to four sides of the diaphragm 20 which is formed in a rectangular shape in a plan view (hereinafter, simply referred to as a “plan view”) which is viewed from a thickness direction of the substrate 2.

The piezoelectric resistive element 5a extends in a direction perpendicular to the corresponding side of the diaphragm 20. A pair of wires 214a are electrically connected to both ends of the piezoelectric resistive element 5a. Similarly, the piezoelectric resistive element 5b extends in a direction perpendicular to the corresponding side of the diaphragm 20. A pair of wires 214b are electrically connected to both ends of the piezoelectric resistive element 5b.

On the other hand, the piezoelectric resistive element 5c extends in a direction parallel to the corresponding side of the diaphragm 20. A pair of wires 214c are electrically connected to both ends of the piezoelectric resistive element 5c. Similarly, the piezoelectric resistive element 5d extends in a direction parallel to the corresponding side of the diaphragm 20. A pair of wires 214d are electrically connected to both ends of the piezoelectric resistive element 5d.

Hereinafter, the wires 214a, 214b, 214c and 214d are referred to as wires 214.

Each of the piezoelectric resistive elements 5 and the wires 214 is formed of silicon (single crystal silicon) which is doped (diffused or injected) with impurities such as phosphor or boron. Here, the doping concentration of the impurities in the wires 214 is higher than the doping concentration in the piezoelectric resistive element 5. The wires 214 may be made of metal.

The plurality of piezoelectric resistive elements 5 are configured to have the same resistance value as each other in a natural state, for example.

The above-described piezoelectric resistive elements 5 form a bridge circuit (Wheatstone bridge circuit) via the wires 214 and the like. The bridge circuit is connected to a driving circuit (not illustrated) which supplies a driving voltage. The bridge circuit outputs a signal (voltage) corresponding to the resistance value of the piezoelectric resistive elements 5.

### Stacked Structure

The stacked structure 6 is formed so as to define the cavity S along with the above-described substrate 2. Here, the stacked structure 6 is disposed on the piezoelectric resistive element 5 side of the diaphragm 20, and defines (forms) the cavity S (internal space) along with the diaphragm 20 (or the substrate 2).

The stacked structure 6 includes an interlayer insulating film 61 which is formed on the substrate 2 so as to surround the piezoelectric resistive element 5 in a plan view; a wiring layer 62 formed on the interlayer insulating film 61; an interlayer insulating film 63 formed on the wiring layer 62 and the interlayer insulating film. 61; a wiring layer 64 including a coating layer 641 which is formed on the interlayer insulating film 63 and has a plurality of fine holes 642 (openings); a surface protection film 65 which is formed on the wiring layer 64 and the interlayer insulating film 63; and a sealing layer 66 provided on the coating layer 641.

Each of the interlayer insulating films 61 and 63 is formed of, for example, a silicon oxide film. Each of the wiring layers 62 and 64 and the sealing layer 66 is made of a metal such as aluminum. The sealing layer 66 seals the fine holes 642 of the coating layer 641. The surface protection film 65 is, for example, a silicon nitride film.

In the stacked structure 6, a structure formed of the wiring layer 62 and the wiring layer 64 excluding the coating layer 641 constitutes a “wall portion” which is disposed so as to surround the piezoelectric resistive element 5 in a plan view on one surface side of the substrate 2. The coating layer 641 constitutes a “ceiling portion” which is disposed on an opposite side to the substrate 2 with respect to the wall portion and forms the cavity S (internal space) along with the wall portion. In addition, the wall portion, the ceiling portion, and content related thereto will be described later in detail.

The stacked structure 6 may be formed by using the same semiconductor manufacturing process as a CMOS process. In addition, semiconductor circuits may be formed on and over the silicon layer 213. The semiconductor circuit includes active elements such as a MOS transistor, and circuit elements which are formed as necessary, such as a capacitor, an inductor, a resistor, a diode, and a wiring (including the wires connected to the piezoelectric resistive element 5).

The cavity S defined by the substrate 2 and the stacked structure 6 is a sealed space. The cavity S functions as a pressure reference chamber which provides a reference value of pressure detected by the physical quantity sensor 1. In the present embodiment, the cavity S is in a vacuum state (300 Pa or less).

Since the cavity S is in a vacuum state, the physical quantity sensor 1 can be used as an “absolute pressure sensor” which detects pressure with the vacuum state as a reference, and thus convenience thereof is improved.

However, the cavity S may not be in a vacuum state, and may be in an atmospheric pressure state, in a depressurized state in which the air pressure is lower than in the atmospheric pressure, or in a pressurized state in which the air pressure is higher than in the atmospheric pressure. The cavity S may be sealed with an inert gas such as a nitrogen gas or a rare gas. If the cavity S is a sealed space, the physical quantity sensor 1 can be used as an “absolute pressure sensor”.

As mentioned above, the configuration of the physical quantity sensor 1 has been described briefly.

In the physical quantity sensor 1 having the configuration, as illustrated in FIG. 3A, the diaphragm 20 is deformed according to a pressure P which is received by the pressure receiving surface 25 of the diaphragm 20, as a result, as illustrated in FIG. 3B, the piezoelectric resistive elements 5a, 5b, 5c and 5d are strained, and thus resistance values of the piezoelectric resistive elements 5a, 5b, 5c and 5d change. Therefore, an output value of the bridge circuit constituted of the piezoelectric resistive elements 5a, 5b, 5c and 5d changes, and the magnitude of the pressure received by the pressure receiving surface 25 can be obtained on the basis of the output value.

More specifically, in a natural state before the deformation of the diaphragm 20 occurs as described above, for example, in a case where the resistance values of the piezoelectric resistive elements 5a, 5b, 5c and 5d are the same as each other, a product of the resistance values of the piezoelectric resistive elements 5a and 5b is the same as a product of the resistance values of the piezoelectric resistive elements 5c and 5d, and an output value (potential difference) of the bridge circuit is zero.

On the other hand, if the diaphragm 20 is deformed as described above, as illustrated in FIG. 3B, compressive strains in a length direction and tensile strains in a width direction occur in the piezoelectric resistive elements 5a and 5b, and tensile strains in a length direction and compressive strains in a width direction occur in the piezoelectric resistive elements 5c and 5d. Therefore, when the diaphragm 20 is deformed as described above, ones of the resistance values of the piezoelectric resistive elements 5a and 5b and the resistance values of the piezoelectric resistive elements 5c and 5d increase, and the others decrease.

There is the occurrence of a difference between the product of the resistance values of the piezoelectric resistive elements 5a and 5b and the product of the resistance values of the piezoelectric resistive elements 5c and 5d due to the strains of the piezoelectric resistive elements 5a, 5b, 5c and 5d, and thus an output value (potential difference) corresponding to the difference is output from the bridge circuit. It is possible to obtain the magnitude (absolute pressure) of the pressure received by the pressure receiving surface 25 on the basis of the output value from the bridge circuit.

Here, since ones of the resistance values of the piezoelectric resistive elements 5a and 5b and the resistance values of the piezoelectric resistive elements 5c and 5d increase, and the others decrease when the diaphragm 20 is deformed as described above, a difference change between the product of the resistance values of the piezoelectric resistive elements 5a and 5b and the product of the resistance values of the piezoelectric resistive elements 5c and 5d can be increased, and thus it is possible to increase an output value from the bridge circuit. As a result, it is possible to increase pressure detection sensitivity.

### Wall Portion and Ceiling Portion

Hereinafter, the wall portion and the ceiling portion will be described in detail.

An inner circumferential edge 643 of an end portion on an opposite side to the substrate 2 of the structure (wall portion) constituted of the wiring layer 62 and the wiring layer 64 excluding the coating layer 641 (ceiling portion) includes four curved portions 6431 which are curved in a plan view. In other words, it can also be said that a connecting portion between a surface of the coating layer 641 opposing the main surface of the substrate 2 with the cavity S interposed therebetween and the wall portion includes four parts which are curved in a cross-section in a direction along the main surface of the substrate 2. In the above-described way, by substantially eliminating a portion of the inner circumferential edge 643 which is curved with a right angle or an acute angle in a plan view (a portion which tends to cause stress to be concentrated on the coating layer 641), it is possible to reduce stress which is concentrated on the coating layer 641 when the coating layer 641 is thermally contracted. For this reason, it is possible to reduce damage due to the thermal contraction of the coating layer 641. The inner circumferential edge 643 is included in a portion excluding the coating layer 641 of the wiring layer 64, that is, a portion of the wiring layer 64 which penetrates through the interlayer insulating film 63.

In contrast, if the inner circumferential edge 643 has a rectangular shape, the inner circumferential edge 643 has corner portions which are curved with a right angle or an acute angle in a plan view, strength of portions of the coating layer 641 corresponding to the corner portions extremely increases compared to the other portions. Thus, when the coating layer 641 is thermally contracted or the like, stress tends to be concentrated between portions of the coating layer 641 corresponding to the corner portions and other portions, and, as a result, damage such as cracking is likely to occur in the coating layer 641.

In the present embodiment, the inner circumferential edge 643 has a shape in which each corner portion of the rectangular shape thereof is rounded in a plan view, and the curved portion 6431 corresponds to each corner portion. As mentioned above, if the curved portion 6431 has a circular arc shape in a plan view, it is possible to effectively reduce stress which is concentrated on the coating layer 641 when the coating layer 641 is thermally contracted.

In the present embodiment, an inner circumferential edge 621 of an end portion on an opposite side to the substrate 2 of the structure (wall portion) constituted of the wiring layer 62 and the wiring layer 64 excluding the coating layer 641 has a shape formed along the inner circumferential edge 643. In other words, the inner circumferential edge 621 has a shape in which each corner portion of the rectangular shape thereof is rounded in a plan view in the same manner as the inner circumferential edge 643. Thus, it is possible to prevent the wiring layer 62 from unexpectedly impeding deflection deformation due to received pressure in the diaphragm 20, and also to reduce an unnecessary step difference which is formed in the cavity S.

When a width of the inner circumferential edge 643 (a width of the coating layer 641) is indicated by W, and a length of the curved portion 6431 in the width direction is indicated by L, L/W is preferably 0.1 or more and 0.4 or less, more preferably 0.2 or more and 0.4 or less, and further more preferably 0.2 or more and 0.3 or less. Thus, it is possible to effectively reduce stress which is concentrated on the coating layer 641 as described above. In contrast, if L/W is too small or too great, there are cases where stress which is concentrated on the coating layer 641 may not be sufficiently reduced as described above depending on a thickness or a width of the coating layer 641, or the wiring layers 62 and 64 having efficient arrangements or shapes which are suitable for a plan-view shape of the diaphragm 20 may be unlikely to be formed.

A specific width W is not particularly limited, but is, for example, 150 μm or more and 200 μm or less. Here, a thickness of the coating layer 641 is not particularly limited, but it is hard to extremely increase the thickness thereof due to a manufacturing limitation in which the coating layer 641 is formed by using a vapor-phase deposition method. For this reason, generally, if the width W is increased, the coating layer 641 is easily deflected, and there is a tendency for the coating layer 641 to be easily damaged when stress concentration occurs therein as described above if the inner circumferential edge 643 has a rectangular shape.

A curvature radius of the curved portion 6431 is set to correspond to the length L and thus is equivalent to or greater than the length L, but is preferably 1 time or more and 10 times or less the length L. Consequently, a remarkable effect is achieved due to the curved portion 6431 being curved.

In the physical quantity sensor 1, the diaphragm 20 of the substrate 2 is provided at the position overlapping the coating layer 641 in a plan view, and thus undergoes deflection deformation due to received pressure. Consequently, it is possible to implement the physical quantity sensor 1 which can detect pressure. Since the piezoelectric resistive element 5 disposed in the diaphragm 20 is a sensor element which outputs an electric signal due to a strain thereof, it is possible to improve pressure detection sensitivity. As described above, since the contour of the diaphragm 20 is rectangular in a plan view as described above, it is possible to improve the pressure detection sensitivity.

The curved portion 6431 which is curved may be provided alone, and is preferably provided at all positions corresponding to the corner portions of the diaphragm 20 in a plan view.

### Manufacturing Method of Physical Quantity Sensor

Next, a manufacturing method of the physical quantity sensor 1 will be described briefly.

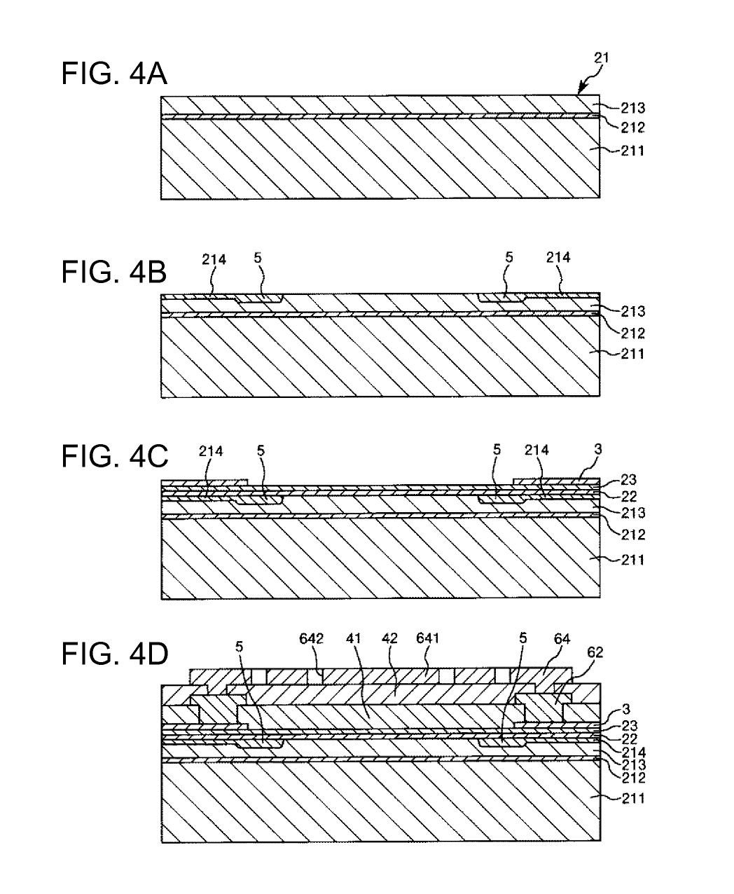

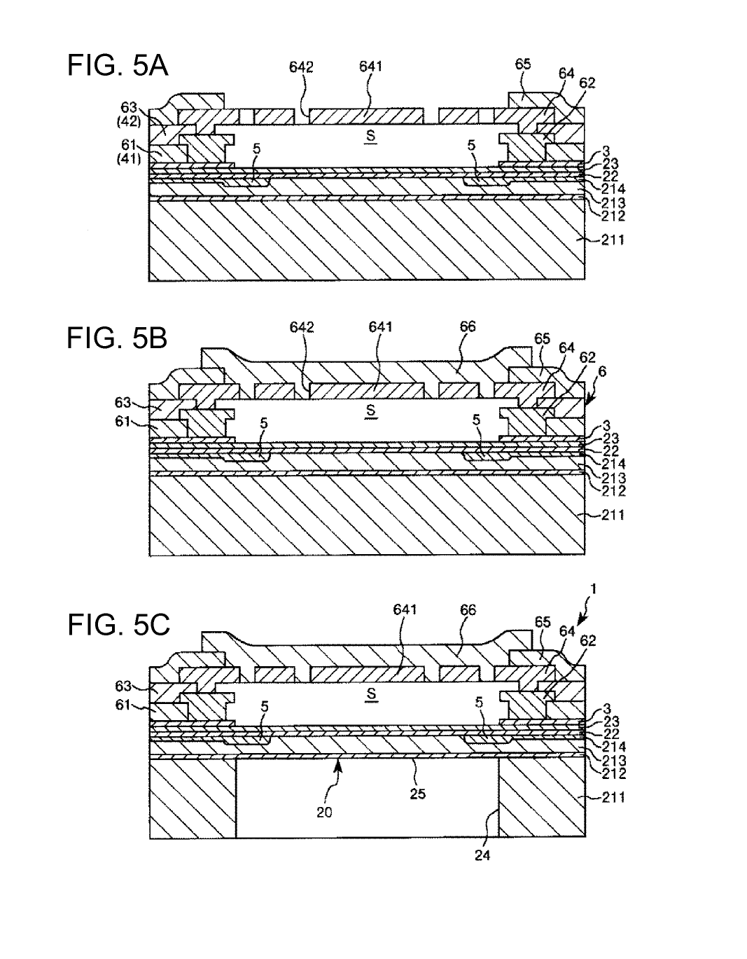

FIGS. 4A to 5C are diagrams illustrating manufacturing steps of the physical quantity sensor illustrated in FIG. 1. Hereinafter, the manufacturing of the physical quantity sensor 1 will be described on the basis of the drawings.

### Element Formation Step

First, as illustrated in FIG. 4A, the semiconductor substrate 21 which is an SOI substrate is prepared.

The silicon layer 213 of the semiconductor substrate 21 is doped with (implanted with ions) impurities such as phosphor (n-type) or boron (p-type), and thus a plurality of piezoelectric resistive elements 5 and wires 214 are formed as illustrated in FIG. 4B.

For example, in a case where boron ion implantation is performed at +80 keV, the concentration of ions to be implanted into the piezoelectric resistive elements 5 is set to about 1×10¹⁴ atoms/cm². The concentration of ions to be implanted into the wires 214 is higher than that which is implanted into the piezoelectric resistive elements 5. For example, in a case where boron ion implantation is performed at 10 keV, the concentration of ions to be implanted into the wires 214 is set to about 5×10¹⁵ atoms/cm². After the above-described ion implantation is performed, for example, annealing is performed for twenty minutes at about 1000° C.

### Formation Step of Insulating Film and the Like

Next, as illustrated in FIG. 4C, the insulating film 22, the insulating film 23, and the intermediate layer 3 are formed in this order on the silicon layer 213.

The insulating films 22 and 23 may be formed by using, for example, a sputtering method and a CVD method. The intermediate layer 3 may be formed by forming a film of polysilicon according to the sputtering method or the CVD method, by doping (performing ion implantation on) the film with impurities such as phosphor or boron as necessary, and then by patterning the film through etching.

### Formation Step of Interlayer Insulating Film and Wiring Layer

Next, as illustrated in FIG. 4D, a sacrificial layer 41, the wiring layer 62, a sacrificial layer 42, and the wiring layer 64 are formed in this order on the insulating film 23.

The sacrificial layers 41 and 42 are partially removed in a cavity formation step which will be described later, and the remaining sacrificial layers 41 and 42 respectively become the interlayer insulating films 61 and 63. The sacrificial layers 41 and 42 are formed by forming silicon oxide films according to a sputtering method, a CVD method, or the like, and by patterning the silicon oxide films through etching.

A thickness of each of the sacrificial layers 41 and 42 is not particularly limited, but is, for example, about 1000 nm or more and 5000 nm or less.

The wiring layers 62 and 64 are formed by forming, for example, aluminum layers according to a sputtering method, a CVD method, or the like, and by patterning the aluminum layers through etching.

A thickness of each of the wiring layers 62 and 64 is not particularly limited, but is, for example, about 300 nm or more and 900 nm or less.

The stacked structure constituted of the sacrificial layers 41 and 42 and the wiring layers 62 and 64 is formed by using a typical CMOS process, and the number of stacked layers is appropriately set as necessary. In other words, more sacrificial layers or wiring layers may be stacked as necessary.

### Cavity Formation Step

Next, the sacrificial layers 41 and 42 are partially removed, and thus the cavity S is formed between the insulating film 23 and the coating layer 641 as illustrated in FIG. 5A. Therefore, the interlayer insulating films 61 and 63 are formed.

The cavity S is formed by partially removing the sacrificial layers 41 and 42 through etching using a plurality of fine holes 642 formed in the coating layer 641. Here, in a case where wet etching is used as such etching, an etchant such as hydrofluoric acid or buffer hydrofluoric acid is supplied from the plurality of fine holes 642, and, in a case where dry etching is used, an etching gas such as a hydrofluoric acid gas is supplied from the plurality of fine holes 642. The insulating film 23 functions as an etching stopper layer during the etching. The insulating film 23 has resistance to the etchant and thus also has a function of protecting the underlying constituent portions (for example, the insulating film 22, the piezoelectric resistive elements 5, and the wires 214) of the insulating film 23 from the etchant.

Here, the surface protection film 65 is formed according to a sputtering method, a CVD method, or the like, before performing the etching. Consequently, the portions of the sacrificial layers 41 and 42 which become the interlayer insulating films 61 and 63 can be protected during the etching. A material forming the surface protection film 65 may include a film having resistance for protecting the element from moisture, dust, or scratch, such as a silicon oxide film, a silicon nitride film, a polyimide film, and an epoxy resin film, and, particularly, the silicon nitride film is preferably used. A thickness of the surface protection film 65 is not particularly limited, but is, for example, about 500 nm or more and 2000 nm or less.

### Sealing Step

Next, as illustrated in FIG. 5B, the sealing layer 66 formed of a silicon oxide film, a silicon nitride film, or a metal film such as Al, Cu, W, Ti, or TiN is formed on the coating layer 641 according to a sputtering method, a CVD method, or the like, so as to seal the fine holes 642. Consequently, the cavity S is sealed with the sealing layer 66, and thus the stacked structure 6 is obtained.

Here, a thickness of the sealing layer 66 is not particularly limited, but is, for example, about 1000 nm or more and 5000 nm or less.

### Diaphragm Formation Step

Next, a part of a lower surface of the silicon layer 211 is removed (processed) through etching after grinding the lower surface of the silicon layer 211 as necessary, and thus the recess 24 is formed as illustrated in FIG. 5C. Consequently, the diaphragm 20 which opposes the coating layer 641 via the cavity S is formed.

Here, when the part of the lower surface of the silicon layer 211 is removed, the silicon oxide layer 212 functions as an etching stopper layer. Consequently, a thickness of the diaphragm 20 can be specified with high accuracy.

As a method of removing the part of the lower surface of the silicon layer 211, dry etching, wet etching, and the like may be employed.

The physical quantity sensor 1 can be manufactured through the above-described steps.

### Second Embodiment

Next, a second embodiment of the invention will be described.

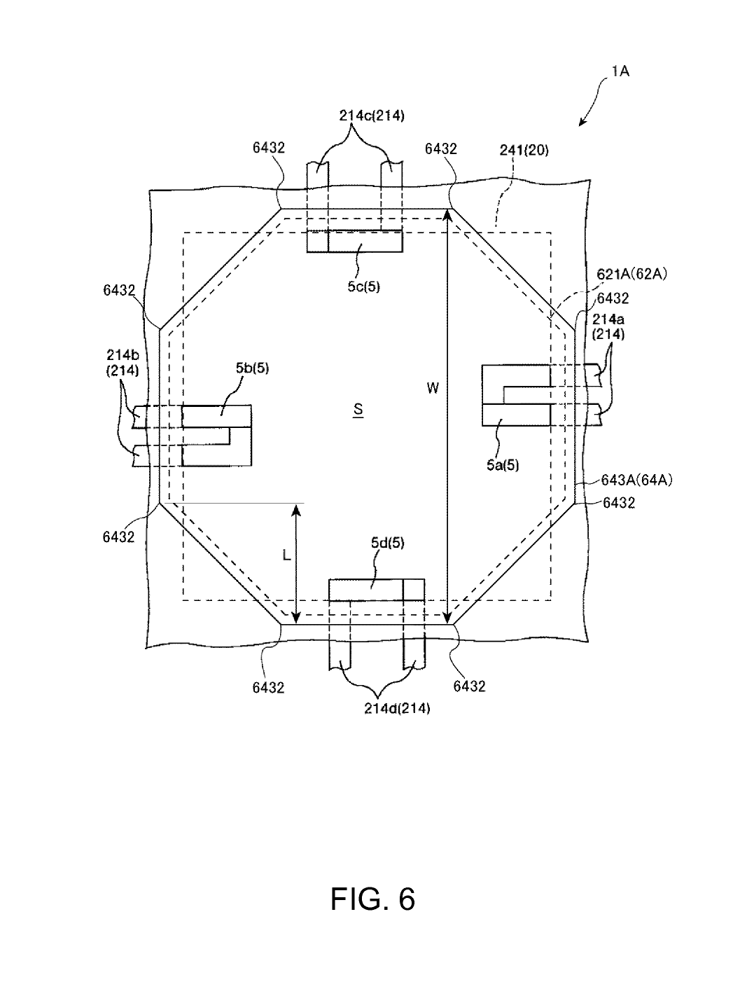

FIG. 6 is a plan view illustrating an arrangement of a piezoelectric resistive element (sensor element) and a wall portion of a physical quantity sensor according to the second embodiment of the invention.

Hereinafter, the second embodiment of the invention will be described focusing on differences from the above-described embodiment, and description of repeated content will be omitted.

The present embodiment is the same as the first embodiment except for the shapes of a wall portion and a ceiling portion.

A physical quantity sensor 1A illustrated in FIG. 6 includes wiring layers 62A and 64A. A coating layer (not illustrated) included in the wiring layer 64A forms a “ceiling portion”, and a structure constituted of the wiring layer 62A and the wiring layer 64A excluding the ceiling portion forms a “wall portion”.

An inner circumferential edge 643A of an end portion of the wall portion on an opposite side to the substrate (not illustrated) includes eight curved portions 6432 (corner portions) which are curved in a plan view. In other words, the inner circumferential edge 643A has an octagonal shape in a plan view.

As mentioned above, since the number of portions corresponding to corner portions is five or more, even if the inner circumferential edge 643A has curved portions (corner portions) in a plan view, all curved angles thereof may be obtuse angles. In other words, it is possible to eliminate a portion of the inner circumferential edge 643A which is curved with a right angle or an acute angle in a plan view around the entire circumference.

In the present embodiment, an inner circumferential edge 621A of an end portion of the wall portion on the substrate side has a shape formed along the inner circumferential edge 643A. In other words, the inner circumferential edge 621A has an octagonal shape in a plan view in the same manner as the inner circumferential edge 643A. A plan-view shape of the inner circumferential edge 621A is not particularly limited, and may have a rectangular shape in the same manner as that of the diaphragm 20.

All four positions corresponding to the corner portions of the diaphragm 20 in a plan view may not have obtuse angles, and may have combinations of obtuse angles and curves. In other words, if one position has an obtuse angle, another position has a curve, and the remaining two positions have right angles, a remarkable effect can be achieved at the positions having the obtuse angle and the curve.

Also in the above-described second embodiment, it is possible to reduce a damage of the ceiling portion included in the wiring layer 64A.

### Third Embodiment

Next, a third embodiment of the invention will be described.

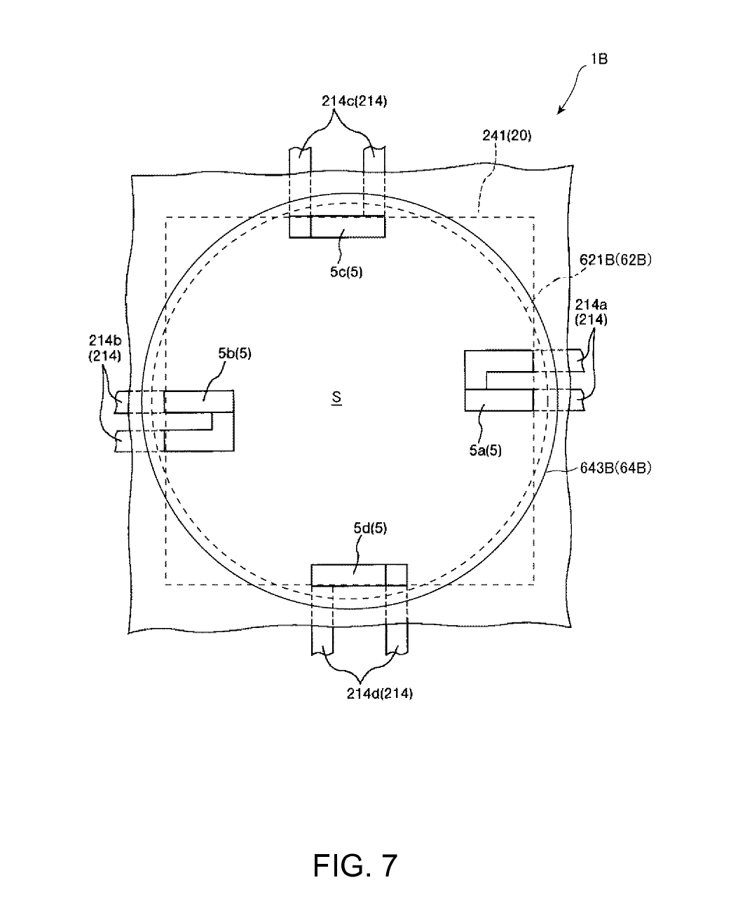

FIG. 7 is a plan view illustrating an arrangement of a piezoelectric resistive element (sensor element) and a wall portion of a physical quantity sensor according to the third embodiment of the invention.

Hereinafter, the third embodiment of the invention will be described focusing on differences from the above-described embodiments, and description of repeated content will be omitted.

The present embodiment is the same as the first embodiment except for shapes of a wall portion and a ceiling portion.

A physical quantity sensor 1B illustrated in FIG. 7 includes wiring layers 62B and 64B. A coating layer (not illustrated) included in the wiring layer 64B forms a “ceiling portion”, and a structure constituted of the wiring layer 62B and the wiring layer 64B excluding the ceiling portion forms a “wall portion”.

An inner circumferential edge 643B of an end portion of the wall portion on an opposite side to the substrate (not illustrated) has a circular shape in a plan view. In other words, the inner circumferential edge 643B can be said to have a plurality of portions which are curved in a plan view.

As mentioned above, if the inner circumferential edge 643B has a circular shape in a plan view, it is possible to effectively reduce stress which is concentrated on the ceiling portion when the ceiling portion is thermally contracted. The inner circumferential edge 643B may have an elliptical shape in a plan view.

In the present embodiment, an inner circumferential edge 621B of an end portion of the wall portion on the substrate side has a shape formed along the inner circumferential edge 643B. In other words, the inner circumferential edge 621B has a circular shape in a plan view in the same manner as the inner circumferential edge 643B. A plan-view shape of the inner circumferential edge 621B is not particularly limited, and may have a rectangular shape in the same manner as that of the diaphragm 20.

Also in the above-described third embodiment, it is possible to reduce damage to the ceiling portion included in the wiring layer 64B.

### Fourth Embodiment

Next, a fourth embodiment of the invention will be described.

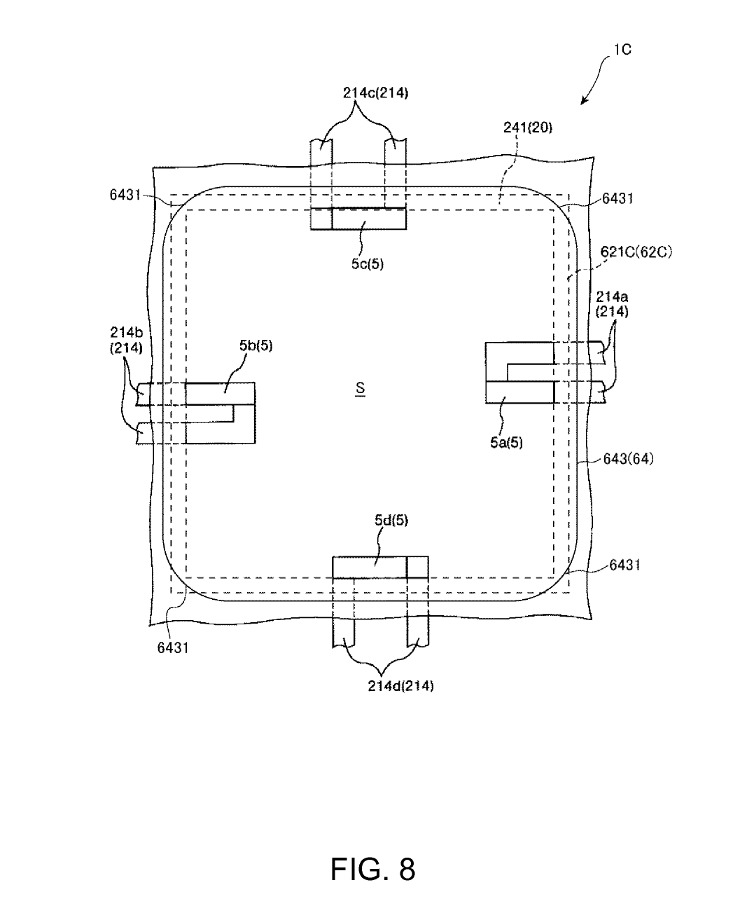

FIG. 8 is a plan view illustrating an arrangement of a piezoelectric resistive element (sensor element) and a wall portion of a physical quantity sensor according to the fourth embodiment of the invention.

Hereinafter, the fourth embodiment of the invention will be described focusing on differences from the above-described embodiments, and description of repeated content will be omitted.

The present embodiment is the same as the first embodiment except for shapes of a wall portion and a ceiling portion.

A physical quantity sensor 1C illustrated in FIG. 8 includes wiring layers 62C and 64. A coating layer (not illustrated) included in the wiring layer 64 forms a “ceiling portion”, and a structure constituted of the wiring layer 62C and the wiring layer 64 excluding the ceiling portion forms a “wall portion”.

An inner circumferential edge 621C of an end portion of the wall portion on the substrate side has a rectangular shape in a plan view. Consequently, it is possible to prevent the wall portion from unexpectedly impeding deflection deformation due to received pressure in the diaphragm 20 having a rectangular shape in a plan view, and also to efficiently dispose the wall portion.

Also in the above-described fourth embodiment, it is possible to reduce a damage of the ceiling portion included in the wiring layer 64.

### 2. Pressure Sensor

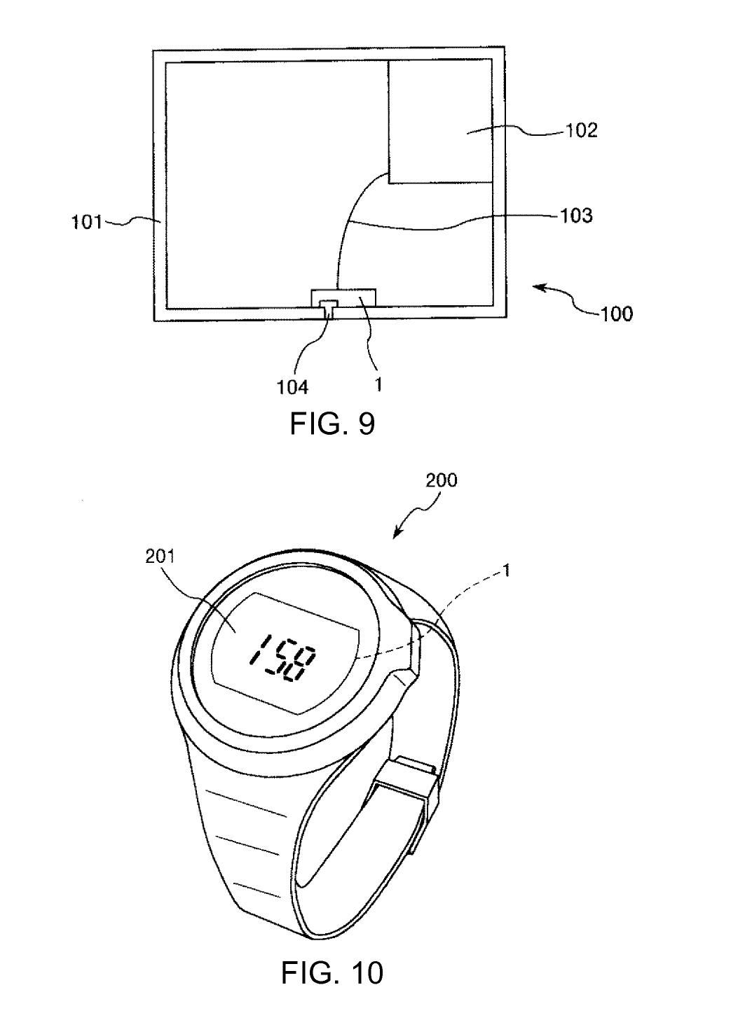

Next, a pressure sensor (a pressure sensor according to an embodiment of the invention) including the physical quantity sensor according to an embodiment of the invention will be described. FIG. 9 is a sectional view illustrating an example of a pressure sensor according to an embodiment of the invention.

As illustrated in FIG. 9, a pressure sensor 100 according to an embodiment of the invention includes the physical quantity sensor 1, a casing 101 which stores the physical quantity sensor 1, and a calculation unit 102 which converts a signal obtained from the physical quantity sensor 1 into pressure data. The physical quantity sensor 1 is electrically connected to the calculation unit 102 via a wire 103.

The physical quantity sensor 1 is fixed inside the casing 101 via a fixation mechanism (not illustrated). The casing 101 is provided with a through hole 104 through which the diaphragm 20 of the physical quantity sensor 1 communicates with, for example, the atmosphere (the outside of the casing 101).

According to the pressure sensor 100, the diaphragm 20 receives pressure via the through hole 104. A signal corresponding to the received pressure is transmitted to the calculation unit 102 via the wire 103, and is converted into pressure data. The calculated pressure data may be displayed on a display unit (not illustrated) (for example, a monitor of a personal computer).

### 3. Altimeter

Next, a description will be made of an example of an altimeter including the physical quantity sensor according to an embodiment of the invention. FIG. 10 is a perspective view illustrating an example of an altimeter according to an embodiment of the invention.

An altimeter 200 may be mounted on the wrist like a wristwatch. The physical quantity sensor 1 (the pressure sensor 100) is mounted in the altimeter 200, and thus an altitude of the present location above sea level, the atmospheric pressure of the present location, or the like can be displayed on a display unit 201.

Various pieces of information such as the present time, a user's heart rate, and weather may be displayed on the display unit 201.

### 4. Electronic Apparatus

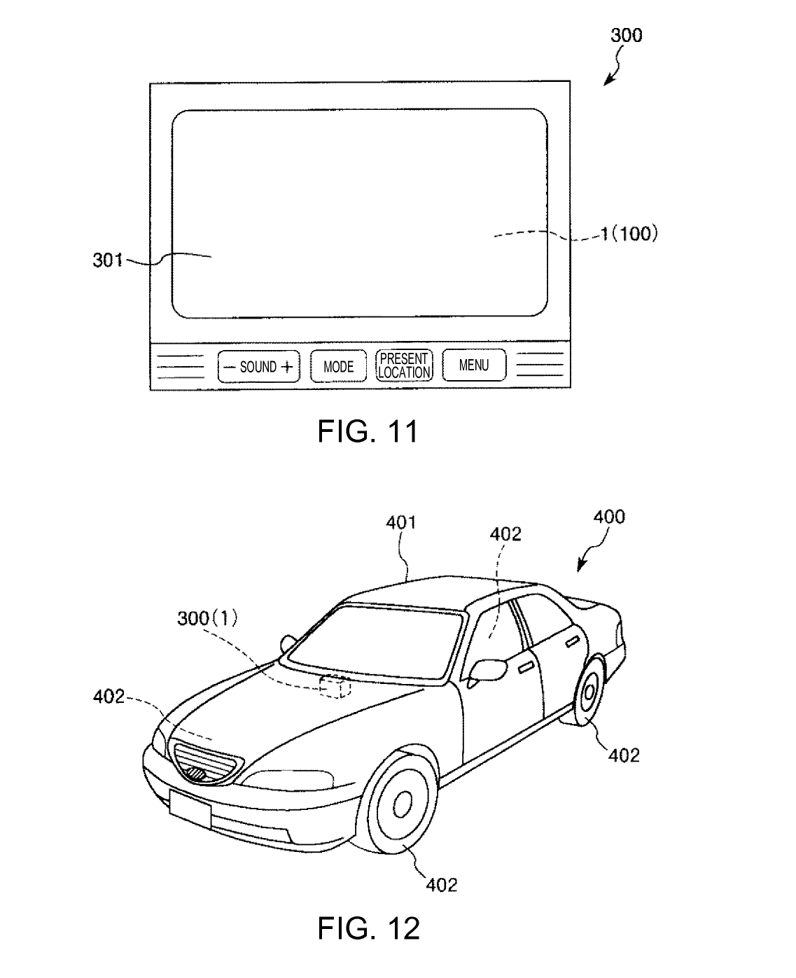

Next, a description will be made of a navigation system to which an electronic apparatus including the physical quantity sensor according to an embodiment of the invention is applied. FIG. 11 is a front view illustrating an example of an electronic apparatus according to an embodiment of the invention.

A navigation system 300 includes a position information acquisition unit that acquires position information on the basis of map information and a global positioning system (GPS) (not illustrated); a self-contained navigation unit which includes a gyro sensor and an acceleration sensor and performs navigation based on vehicle velocity data; the physical quantity sensor 1; and a display unit 301 which displays predetermined position information or course information.

According to the navigation system, it is possible to acquire altitude information in addition to position information. Since the altitude information is acquired, for example, in a case where a vehicle travels along an elevated road which has the substantially same position as that of a general road in terms of position information, the navigation system cannot determine whether the vehicle travels along a general road or an elevated road unless the altitude information is acquired, and provides information regarding the general road to a user as priority information. Therefore, the navigation system 300 according to the present embodiment can acquire altitude information by using the physical quantity sensor 1, can detect an altitude change due to initial movement from a general road to an elevated road, and can provide navigation information of a traveling state on the elevated road to a user.

The display unit 301 has a configuration capable of achieving a small size and being thin, such as a liquid crystal panel display or an organic electroluminescent (EL) display.

An electronic apparatus including the physical quantity sensor according to the embodiment of the invention is not limited thereto, and may be applied, for example, to a personal computer, a mobile phone, a medical apparatus (for example, an electronic thermometer, a sphygmomanometer, a blood glucose monitoring system, an electrocardiographic apparatus, an ultrasonic diagnostic apparatus, or an electronic endoscope), various measurement apparatuses, meters and gauges (for example, meters and gauges of vehicles, aircrafts, and ships), and a flight simulator.

### 5. Moving Object

Next, a description will be made of a moving object (a moving object according to an embodiment of the invention) to which the physical quantity sensor according to the embodiment of the invention is applied. FIG. 12 is a perspective view illustrating an example of a moving object according to an embodiment of the invention.

As illustrated in FIG. 12, a moving object 400 includes a car body 401 and four wheels 402, and the wheels 402 are rotated by a power source (engine) provided in the car body 401. The navigation system 300 (the physical quantity sensor 1) is built into the moving object 400.

As mentioned above, the electronic device, the physical quantity sensor, the pressure sensor, the altimeter, the electronic apparatus, and the moving object according to the embodiments of the invention have been described with reference to the drawings, but the invention is not limited thereto, and a configuration of each part according to the embodiments of the invention may be replaced with any configuration having the same function as in the above-described embodiments. Any configuration may be added thereto.

Regarding the number of piezoelectric resistive elements (functional elements) provided in a single diaphragm, a case where the number thereof is four has been described as an example in the above embodiments, but the number of piezoelectric resistive elements may be one or more and three or less, or five or more. An arrangement or a shape of the piezoelectric resistive element is not limited to that in the above-described embodiments, and, for example, in the above-described embodiments, the piezoelectric resistive element may be disposed at the center of the diaphragm.

In the above embodiments, a description has been made of an example of a case where the piezoelectric resistive element is used as a sensor element detecting deflection of the diaphragm, but a sensor element is not limited thereto and may be, for example, a resonator.

In the above embodiments, a description has been made of an example of a case where the electronic device according to the embodiment of the invention is applied to the physical quantity sensor, but the invention is not limited thereto. As described above, the invention is applicable to various electronic devices in which a wall portion and a ceiling portion are formed on the substrate by using a semiconductor manufacturing process, and an internal space is formed by the substrate, the wall portion and the ceiling portion. In this case, a diaphragm may be omitted.

What is claimed is:

1. An electronic device comprising:
a substrate;
a functional element that is disposed on the substrate;
a wall portion that is disposed on one surface side of the substrate so as to surround the functional element in a plan view of the substrate; and
a ceiling portion that is disposed on an opposite side to the substrate with respect to the wall portion and forms an internal space along with the substrate and the wall portion,
wherein an inner circumferential edge of an end portion of the wall portion on the ceiling portion side includes curved portions which are bent or curved with an obtuse angle in the plan view.

2. The electronic device according to claim 1,
wherein the number of the curved portions is five or more.

3. The electronic device according to claim 1,
wherein each of the curved portions has a shape formed along a circular arc in the plan view.

4. The electronic device according to claim 1,
wherein the inner circumferential edge has a circular shape or an elliptical shape in the plan view.

5. The electronic device according to claim 1,
wherein the substrate includes a diaphragm that is provided at a position which overlaps at least a part of the ceiling portion in the plan view and that undergoes deflection deformation due to received pressure.

6. The electronic device according to claim 5,
wherein the functional element is a sensor element which outputs an electric signal due to a strain thereof.

7. The electronic device according to claim 6,
wherein a contour of the diaphragm is a rectangular shape in the plan view.

8. The electronic device according to claim 1,
wherein the inner circumferential edge of the end portion of the wall portion on the substrate side has a rectangular shape in the plan view.

9. A physical quantity sensor comprising:
the electronic device according to claim 5,
wherein the functional element is a sensor element.

10. A pressure sensor comprising the electronic device according to claim 1.

11. A pressure sensor comprising the electronic device according to claim 2.

12. A pressure sensor comprising the electronic device according to claim 3.

13. An altimeter comprising the electronic device according to claim 1.

14. An altimeter comprising the electronic device according to claim 2.

15. An altimeter comprising the electronic device according to claim 3.

16. An electronic apparatus comprising the electronic device according to claim 1.

17. An electronic apparatus comprising the electronic device according to claim 2.

18. An electronic apparatus comprising the electronic device according to claim 3.

19. A moving object comprising the electronic device according to claim 1.

20. A moving object comprising the electronic device according to claim 2.
